(19) United States
(12) Patent Application Publication
(10) Pub. No.: US 2025/0242794 A1
(43) Pub. Date: Jul. 31, 2025

(54) POWERTRAIN, A METHOD FOR CONTROLLING A POWERTRAIN, AND A VEHICLE

(71) Applicant: Volvo Truck Corporation, GÖTEBORG (SE)

(72) Inventor: Fredrik Karpenman, Västra Frölunda (SE)

(21) Appl. No.: 19/004,629

(22) Filed: Dec. 30, 2024

(30) Foreign Application Priority Data
Jan. 25, 2024 (EP) 24153990.7

(51) Int. Cl. B60W 20/15; B60K 17/28; B60W 10/02; B60W 10/08; B60W 20/50; B60W 30/188; B60W 50/029

(52) U.S. Cl. CPC B60W 20/15; B60K 17/28; B60W 10/02; B60W 10/08; B60W 20/50; B60W 30/188; B60W 50/029

(57) ABSTRACT

The disclosure relates to a powertrain for a vehicle, comprising: a first electric machine to drive a propeller shaft, a power take-off device to be driven by the first electric machine, a power take-off clutch to mechanically engage or disengage the power take-off device, a control unit to control rotational speed of the first electric machine and to control the power take-off clutch, a transmission comprising shafts to drivingly connect the first electric machine to drive the power take-off device and the propeller shaft, and where upon an operation demand to disengage the power take-off device, the control unit is adapted to first control the first electric machine to brake rotational speed of the power take-off device to zero, and then to control the power take-off clutch to a disengaged position, in order to disengage the power take-off device with zero rotational speed.

### CROSS REFERENCE TO RELATED APPLICATIONS

This application claims priority to European Patent Application No. 24153990.7, filed on 25 Jan. 2024, the disclosure and content of which is incorporated by reference herein in its entirety.

### TECHNICAL FIELD

The disclosure relates to a powertrain, a method for controlling a powertrain, a control unit, and a vehicle.

The disclosure can be applied in heavy-duty vehicles, such as trucks, buses, and construction equipment. Although the disclosure will be described with respect to a truck, the disclosure is not restricted to this type of vehicle, but may also be used in other vehicles such as buses, trailers, wheel loaders, excavators, etc.

### BACKGROUND

Electrically or partly electrically operated heavy-duty vehicles are becoming increasingly common. For heavy-duty vehicles, it may be desirable to provide a Power Take-Off (PTO) to drive an auxiliary system (PTO device) with an electric motor of the powertrain.

In such powertrains a transmission may be provided, transmitting torque from the electric machine to an output shaft used to propel a driven axle of the vehicle. If there is a second drive unit the output shaft can be common with this second drive unit to drive for example wheels of the vehicle to propel the vehicle.

US20110219900A1 discloses an example of a powertrain unit with electric motor where a transmission is provided with a clutch (K_{PTO}) for engagement/disengagement of a PTO device. The rotational speed of the transmission-side connection point for the auxiliary/PTO device is influenced by means of a transmission brake or an electric motor.

There is an ongoing strive to improve the powertrains of electrically operated vehicles and to secure safer and more efficient functioning of the vehicle.

### SUMMARY

A primary object of the disclosure is to provide an, in at least some aspects, improved powertrain for a vehicle including a PTO device. In particular, it is an object to provide such an improved powertrain which uses an electric machine for propulsion of the vehicle and to also drive the PTO device, when the PTO device is engaged.

According to a first aspect of the disclosure, the above object is achieved by a powertrain for a vehicle according to claim 1. The powertrain comprises:
a first drive unit adapted to drive a propeller shaft,
the first drive unit is a first electric machine,
a power take-off device adapted to be driven by the first electric machine,
a power take-off clutch adapted to be positioned in engaged or disengaged position to mechanically engage or disengage the power take-off device in relation to the first electric machine,
a control unit to control rotational speed of the first electric machine and to control the power take-off clutch to one of the engaged or disengaged position,
a transmission comprising shafts to drivingly connect the first electric machine to drive the power take-off device and the propeller shaft, and where upon an operation demand to disengage the power take-off device, the control unit is adapted to first control the first electric machine to brake rotational speed of the power take-off device to zero, and then the control unit is adapted to control the power take-off clutch to a disengaged position, in order to disengage the power take-off device with zero rotational speed.

In the first aspect of the powertrain the engaged rotating PTO device is first stopped by the first electric machine before executing the disengagement of the PTO device. In this way the PTO device is always ready for re-engagement at any time, since zero PTO rotational speed has been secured already before the disengagement of the PTO. This is of great benefit since the rotational speed of the PTO device otherwise would be unknown, for example, if there is no rotational speed sensor on the PTO device side (auxiliary system side) of the PTO clutch.

By expressions such as “brake rotational speed of the power take-off device to zero”, “zero PTO rotational speed” or “zero rotational speed of the power take-off device” or the like throughout the application is meant that the rotational speed of the PTO-device has reached a total rotational stop or close to a rotational stop.

By “mechanically engage or disengage” is meant that a first and a second rotating part in a disengaged state has no mechanical connection between them to transfer torque from the first rotating part to the second rotating part. Example of connection device to achieve such a mechanical connection can be a coupling sleeve on a shaft adapted to be positioned in a first axial position where a gearwheel is engaged to the shaft and a second axial position where the gearwheel is disengaged from the shaft, and thereby can spin freely in relation to the shaft. Thus, the coupling sleeve is moved in axial direction on the shaft to rotationally engage or disengage a gearwheel in relation to the shaft.

Optionally, the power take-off clutch is a dog clutch.

A situation could occur where for example an operator requests disengagement of the PTO device, and shortly after requests reengagement of the PTO device. This could happen if the operator for example unintentionally has requested disengagement, and suddenly realizes the erratic disengagement request. If the PTO device was rotating upon disengagement, there is a risk that the PTO device is still rotating when the reengagement occurs, which with the PTO clutch being a dog clutch could lead to serious wear of the PTO clutch or in worst case even clutch damage. The powertrain according to the first aspect is therefore particularly beneficial if the PTO clutch is of a dog clutch type (claw clutch type).

In another situation for example the control unit is programmed to disengage the PTO device temporary, in order to provide extra torque from the first electric machine to propulsion of the vehicle instead. Such controlling to temporary disengage the PTO device could occur, for example, when vehicle acceleration is requested during a relatively short time. Without the disclosure this situation could result in difficulty to disengage the PTO clutch if the electric motor still provides torque to the PTO device during disengagement (e g for braking the PTO device), and thereby the torque over the PTO clutch can result in increased disengagement time, or in worst case failure to disengage as long as torque is applied over the PTO clutch and if disengagement device (for example spring-back mechanism or clutch actuator) is not strong enough to be able to disengage. And also here upon reengagement, if the PTO device is still rotating, this could lead to serious wear of the PTO clutch or in worst case even clutch damage. Said problems can be solved with the first aspect of the disclosure by first stopping the rotation of the PTO device before disengaging the PTO clutch. Another advantage with the first aspect is that when the PTO device is not rotating it is easier (less force needed) to disengage the PTO clutch since there is no torque applied over the PTO clutch.

Optionally the transmission comprises a clutch actuator adapted to be controlled by the control unit and thereby disengage or engage the PTO clutch. The clutch actuator can for example be an electric, pneumatic or hydraulic actuator or other according to known art, and the control unit can control the clutch actuator by providing a control medium (for example electricity, air, fluid) to move the actuator between an engaged and disengaged state according to known art. The actuator is mechanically connected to the PTO clutch in a known way to set the PTO clutch in a disengaged or engaged state.

Optionally the transmission in addition comprises:
a first input shaft drivingly connected to the first electric machine,
an output shaft drivingly connected to the propeller shaft,
a second shaft to which the power take-off device is drivingly connectable or connected via the power take-off clutch,
gearwheel pair to drivingly connect the second shaft to one of the first input shaft or the output shaft.

The configuration of the transmission can be a solution with or without a countershaft. In fact, aspects of the disclosure can be implemented with many different transmission configurations according to known art.

By “drivingly connected” or “drivingly connect” of two rotating parts is herein intended that torque can be transmitted between the parts, and that the rotational speeds of the parts are proportional.

When two shafts are drivingly connected, torque can be transmitted from one shaft to the other either directly through a clutch or coupling or other rotationally fixing connection, or through for example a gearwheel pair.

When two gearwheels in a gearwheel pair are drivingly connected, torque can be transmitted between the gearwheels. This may be achieved by the gearwheels being in meshing engagement, or by a first gearwheel being in meshing engagement with a second gearwheel, which is in turn in meshing connection with a third gearwheel, or by a first gearwheel being in meshing engagement with a second gearwheel, which is rigidly connected to a third gearwheel, which is in turn in meshing connection with a fourth gearwheel. Thus, in order to be drivingly connected, it is not necessary that two gearwheels are in meshing engagement. It is sufficient that the rotation of one of the gearwheels inevitably leads to the rotation of the other one of the gearwheels.

By a meshing engagement is intended a permanent meshing engagement.

Optionally the transmission also comprises:
additional gearwheel pairs to drivingly connect the first input shaft to the second shaft, and the second shaft to the output shaft,
the second shaft is a countershaft.

This embodiment specifically defines a transmission comprising at least one countershaft. A transmission configuration with a countershaft can provide a more compact transmission design with increased possibility for additional gear ratios. As already mentioned, aspects of the disclosure can be implemented with many different transmission configurations known in the art.

Optionally the powertrain comprises a second drive unit adapted to drive the propeller shaft via a second input shaft and gearwheel pair.

The second drive unit can be any type of drive unit according to known art adapted to provide additional propulsion torque for propelling the vehicle. The transmission for the first electric machine and the second drive unit can be adapted to provide torque in parallel or one at a time to the propeller shaft according to known art.

Optionally the second drive unit is one of an electric machine or an internal combustion engine or a gas turbine engine.

According to a second aspect of the disclosure, at least the primary object is also achieved by a vehicle comprising a powertrain according to the first aspect. The vehicle may for example be a fully electrified vehicle, or a hybrid vehicle comprising at least one drive unit in the form of a combustion engine in addition to one or two power unit(s) in the form of electric machine(s). Advantages and advantageous features of the vehicle according to the disclosure appear from the above description of the first aspect of the disclosure.

According to a third aspect of the disclosure, a method for controlling a powertrain according to the first aspect is provided. The method comprises:
registering a request to disengage the power take-off device,
braking rotational speed of the power take-off device,
registering zero rotational speed of the power take-off device,
disengaging the power take-off device.

Advantages and advantageous features of the method according to the disclosure appear from the above description of the first aspect of the disclosure. In some examples, the control unit is registering zero rotational speed of the power take-off device by registering that the first electric machine has reached zero rotational speed.

Optionally, the powertrain can further comprise a rotational speed sensor adapted to measure rotational speed of the power take-off device, where the method comprises:
if registering a faulty rotational speed signal from the rotational speed sensor,
then initiating a failsafe mode,
   where the failsafe mode comprises:
if registering a request to disengage the power take-off device,
first braking rotational speed of the power take-off device, and
upon registering zero rotational speed of the power take-off device disengaging the power take-off device.

In some examples, the control unit is registering zero rotational speed of the power take-off device by registering that the first electric machine has reached zero rotational speed. Thus, the first electric machine can be used to register rotational speed of the PTO device.

If the powertrain comprises a rotational speed sensor adapted to measure rotational speed of the power take-off device, and the rotational speed sensor for some reason, for example malfunction, cannot provide an adequate rotational speed signal, then a failsafe mode is initiated. The failsafe mode comprises the method steps according to the third aspect providing the advantages as mentioned above. Thus, the disclosure can be implemented with a powertrain comprising a rotational speed sensor adapted to measure rotational speed of the power take-off device.

Optionally the method comprises the step that before the step of braking rotational speed of the power take-off device, first disengaging the first electric machine from the propeller shaft. By disengaging the first electric machine from the propeller shaft before the braking of the first electric machine starts, the propulsion of the vehicle will be less affected.

According to a fourth aspect of the disclosure, a control unit configured to perform the method according to the third aspect and the optional methods is provided. The control unit may control the clutch actuator for disengaging and engaging the PTO clutch in response to, for example, an operator request or upon the control unit registering a specific vehicle condition. The control unit further comprises electronic circuitry for automatically controlling at least the clutch actuator, and to be able to communicate with other systems and control units of the vehicle.

Further advantages and advantageous features of the disclosure are disclosed in the following description and in the dependent claims.

### BRIEF DESCRIPTION OF THE DRAWINGS

With reference to the appended drawings, below follows a more detailed description of embodiments of the disclosure cited as examples.

In the drawings:

FIG. 1 schematically illustrates a vehicle according to an embodiment of the disclosure,

FIGS. 2a to 2c schematically illustrate a powertrain according to different embodiments of the disclosure,

FIGS. 3a and 3b are flow charts illustrating methods according to different embodiments of the disclosure.

The drawings show diagrammatic exemplifying embodiments of the present disclosure and are thus not necessarily drawn to scale. It shall be understood that the embodiments shown and described are exemplifying and that the disclosure is not limited to these embodiments. It shall also be noted that some details in the drawings may be exaggerated in order to better describe and illustrate aspects of the disclosure. Like reference characters refer to like elements throughout the description, unless expressed otherwise.

### DETAILED DESCRIPTION OF EXAMPLE EMBODIMENTS OF THE DISCLOSURE

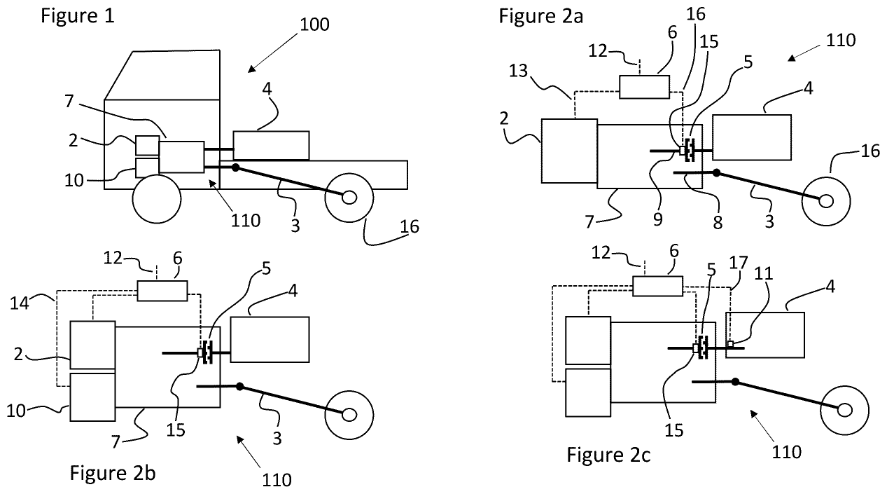

A vehicle 100 in the form of a truck according to an embodiment of the disclosure is shown in FIG. 1. The vehicle 100 comprises a powertrain 110 with a first electric machine 2 for propulsion of the vehicle 100. The powertrain 110 further comprises a second drive unit 10 also for propulsion of the vehicle, and that can be one of, for example, an electric machine, an internal combustion engine or a gas turbine engine. Each of the electric machine 2 and the second drive unit 10 is drivingly connected to a propeller shaft 3 through a transmission 7. The transmission 7 is arranged to transfer torque from the electric machine 2 and the second drive unit 10 to the propeller shaft 3, thereby connecting the powertrain 110 to a driven axle that drives driven wheels 16 of the vehicle 100. The transmission 7 can have different configurations of shafts and gearwheels to provide different gears with different gear ratios according to known art.

The vehicle 100 further comprises a power take-off (PTO) device 4 arranged to be driven by at least the first electric machine 2 through the transmission 7. The PTO device 4 can be of different kind known in the art, and can have great moment of inertia, which means that a relatively large amount of torque is needed if there is a need to alter rotational speed of the PTO device 4 rapidly. This also means that it can take relatively long time before the PTO device stops rotating upon disengagement and if not actively braked. The first electric machine 2 and the second drive unit 10 (if it is an electric machine) are configured to be powered by an electric energy storage system (not shown) of the vehicle 100.

The vehicle and the powertrain may have many different configurations. For example, the drive units 2 and 10, and the transmission 7 do not need to be provided at a front of the vehicle as disclosed in FIG. 1, but may, for example, be combined with a rear axle of the vehicle.

FIG. 2a discloses a powertrain 110 of a vehicle 100 according to a first embodiment of the disclosure, comprising a first electric machine 2 adapted to drive a propeller shaft 3, and when requested to also drive a PTO device 4. Further, a PTO clutch 5 of a dog clutch type is adapted to be positioned in an engaged or disengaged position to mechanically engage or disengage the PTO device 4 in relation to the first electric machine 2. A control unit 6 is adapted to control rotational speed of the first electric machine 2 by communicating signals through electric wire 13 to the first electric machine 2 and upon request from an input signal via electric wire 12. The control unit 6 controls a medium, for example air, hydraulic fluid or electricity (depending of type of actuator) to actuate a clutch actuator 15 through electric wire 16. The clutch actuator 15 is mechanically connected to a part of the PTO clutch movable in axial direction in order to position the PTO clutch 5 in an engaged or disengaged state, and thereby engage or disengage the PTO device 4.

A transmission 7 comprises at least an input shaft (not disclosed) drivingly connected to the first electric machine 2, an output shaft 8 and a second shaft 9 to drivingly connect the first electric machine 2 to drive the PTO device 4 and the propeller shaft 3. The propeller shaft 3 is drivingly connected through the output shaft 8. The different shafts of the transmission 7 can be drivingly connected through gearwheel pairs and in a known way provide different gear ratios when engaged in different combinations. In some examples, the second shaft 9 can be a countershaft. The configuration of the transmission 7 can be realized in many different ways according to known art, and will therefore not be further described in this description. When the PTO device 4 is engaged the control unit 6 can control the rotational speed of the PTO device 4 by controlling the rotational speed of the first electric machine 2.

Thus, the first electric machine 2 can drive the PTO device 4 with a requested rotational speed. Upon an operation demand through electric wire 12 to disengage the PTO device, the control unit 6 is adapted to first control the first electric machine 2 to brake the rotational speed of the PTO device 4 to zero, and then the control unit 6 is adapted to control the PTO clutch 5 to a disengaged position, in order to disengage the PTO device 4 with zero rotational speed. Before the step of braking the rotational speed of the PTO device 4 starts, in some examples, the first electric machine 2 is first disengaged from the propeller shaft 3. The rotational speed of the PTO device 4 is registered by the control unit 6 registering a signal through wire 13 that the first electric machine 2 has reached zero rotational speed.

FIG. 2b discloses a powertrain 110 of a vehicle 100 according to a second embodiment of the disclosure. This embodiment is similar to the first embodiment according to FIG. 2a, but differs in that it is in addition provided with a second drive unit 10, also adapted to drive the propeller shaft 3, but instead via a second input shaft (not disclosed) and additional gearwheel pair or pairs. The second drive unit 10 is in the disclosed example controlled by the control unit 6 via electric wire 14. In some examples, the second drive unit 10 is a second electric machine, but can also be an internal combustion engine or a gas turbine engine, or other propulsion unit type known in the art.

FIG. 2c discloses a powertrain 110 of a vehicle 100 according to a third embodiment of the disclosure. This embodiment is similar to the second embodiment according to FIG. 2b, but differs in that it is in addition provided with a rotational speed sensor 11 adapted to measure rotational speed of the PTO device 4 on the PTO device side of the PTO clutch 5. A rotational speed value of the PTO device 4 is communicated from the rotational speed sensor 11 to the control unit 6 through electric wire 17. In this embodiment the control unit 6 is adapted to register a faulty signal indicating a faulty rotational speed sensor 11. A faulty signal can include, for example, that there is no signal communicated from the rotational speed sensor, or the signal from the rotational speed sensor 11 is registered to be corrupt or obviously wrong, et cetera. If the control unit 6 registers a faulty signal then the control unit is adapted to initiate a failsafe mode. The failsafe mode comprises the steps that if the control unit 6 registers a request to disengage the PTO device 4, the control unit 6 first brakes rotational speed of the PTO device 4, and then when the control unit registers zero rotational speed of the PTO device 4 the control unit 6 is adapted to disengage the PTO device 4. The rotational speed of the PTO device 4 is registered by the control unit 6 registering a signal through wire 13 that the first electric machine 2 has reached zero rotational speed.

In the exemplified embodiments of the disclosure the different shafts in the transmission are mounted to a transmission housing of the transmission 7, for example, using bearings (not disclosed).

In some examples, the transmission 7 is an Automated Mechanical Transmission (AMT).

The electrical wires 12, 13, 14, 16, 17 in FIGS. 2a to 2c indicated as dotted lines can alternatively be communication device using known transmission buses such a CAN-bus and/or wireless communication devices.

In all the exemplified embodiments of the disclosure when the control unit 6 controls the first electric machine 2 to brake the PTO device 4, the braking energy may be converted into electric energy by the electric machine 2, which for example may be utilized for charging the electric energy storage system (not disclosed).

Features from the different embodiments may of course be combined so that, for example, the embodiment of FIG. 2a comprising only one electric machine 2 can be equipped with a rotational speed sensor 15 from the embodiment in FIG. 2c, including the method steps with the failsafe mode of the embodiment of FIG. 2c.

For all the disclosed embodiments of the disclosure during the reengagement of the PTO device 4 the electric machine 2 can be controlled to rotate slowly, in order to avoid a tooth-to-tooth situation in the PTO clutch 5 of dog clutch type. In this way a smoother and safer reengagement can be achieved. A tooth-to-tooth situation is not desirable since the dog clutch can be stuck in a disengaged state, at least temporarily.

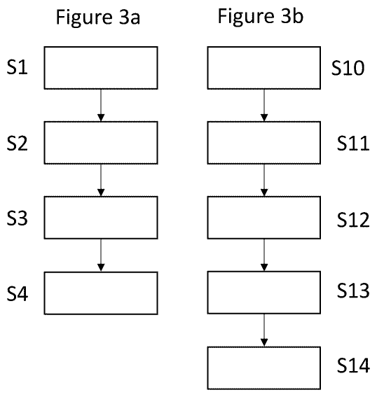

A method for controlling the powertrain 110 according to an embodiment of the disclosure is illustrated in FIG. 3a. The method comprises the following steps:
S1: Registering a request to disengage the PTO device 4,
S2: braking rotational speed of the PTO device 4,
S3: registering zero rotational speed of the PTO device 4,
S4: disengaging the PTO device 4.

A further method for controlling the powertrain 110 according to the embodiment of FIG. 2c with the rotational speed sensor is illustrated in FIG. 3b. Here, the method comprises the following steps:
S10: If registering a faulty rotational speed signal from the rotational speed sensor 11,
S11: then initiating a failsafe mode,
   where the failsafe mode comprises the steps:
S12: if registering a request to disengage the PTO device 4,
S13: first braking rotational speed of the PTO device 4, and
S14: upon registering zero rotational speed of the PTO device 4 disengaging the power take-off device 4.

In step S14 the control unit 6 registers zero rotational speed of the PTO device 4 by registering a signal through wire 13 that the first electric machine 2 has reached zero rotational speed.

The control unit 6 may be an electronic device configured to perform the methods illustrated in FIG. 3a or 3b. It may for this purpose comprise means for controlling the first electric machine 2, means for controlling the second drive unit 10 (if there is any), and means for controlling the transmission 7, including at least the gear engaging devices (such as actuators for coupling sleeves, not shown), and the clutch actuator 15 of the PTO clutch 5. The control unit 6 may be configured to control the powertrain 110 and the PTO clutch 5 in dependence of a request to disengage the PTO device 4.

The control unit 6 may include a microprocessor, a microcontroller, a programmable digital signal processor or another programmable device. Thus, the control unit 6 comprises electronic circuits and connections (not shown) as well as processing circuitry (not shown) such that the control unit 6 can communicate with different parts of the vehicle 100 or with different control units of the vehicle 100, such as with various sensors, systems and control units, in particular with one or more electronic control units (ECUs) controlling electrical systems or subsystems in the vehicle 100, such as an energy storage system control unit of an electric energy storage system (not shown) of the vehicle 100.

The control unit 6 may comprise modules in either hardware or software, or partially in hardware or software, and communicate using known transmission buses such a CAN-bus and/or wireless communication capabilities. The processing circuitry may be a general-purpose processor or a specific processor. The control unit 6 may comprise a non-transitory memory for storing computer program code and data. Thus, the skilled person realizes that the control unit 6 may be embodied through many different constructions.

Although herein illustrated as a single control unit, the control unit 6 may be formed of several different control units configured to communicate with each other, such as separate control units for controlling at least the first electric machine 2 and for controlling the transmission 7. Thus, the software for performing the control of at least the first electric machine 2 and for controlling the transmission 7 can be spread among several control units.

It is to be understood that the present disclosure is not limited to the embodiments described above and illustrated in the drawings; rather, the skilled person will recognize that many changes and modifications may be made within the scope of the appended claims.

1. A powertrain for a vehicle, comprising:
a first drive unit adapted to drive a propeller shaft, the first drive unit is a first electric machine,
a power take-off device adapted to be driven by the first electric machine,
a power take-off clutch adapted to be positioned in engaged or disengaged position to mechanically engage or disengage the power take-off device in relation to the first electric machine,
a control unit to control rotational speed of the first electric machine and to control the power take-off clutch to one of the engaged or disengaged position, and
a transmission comprising shafts to drivingly connect the first electric machine to drive the power take-off device and the propeller shaft,
and where upon an operation demand to disengage the power take-off device, the control unit is adapted to first control the first electric machine to brake rotational speed of the power take-off device to zero, and then the control unit is adapted to control the power take-off clutch to a disengaged position, in order to disengage the power take-off device with zero rotational speed.

2. The powertrain according to claim 1, wherein the power take-off clutch is a dog clutch.

3. The powertrain according to claim 1, wherein the transmission comprises a clutch actuator adapted to be controlled by the control unit and thereby disengage or engage the PTO clutch.

4. The powertrain according to claim 1, wherein the transmission comprises:
a first input shaft drivingly connected to the first electric machine,
an output shaft drivingly connected to the propeller shaft,
a second shaft to which the power take-off device is drivingly connectable or connected via the power take-off clutch, and
a gearwheel pair to drivingly connect the second shaft to one of the first input shaft or the output shaft.

5. The powertrain according to claim 4, wherein the transmission further comprises:
additional gearwheel pairs to drivingly connect the first input shaft to the second shaft, and the second shaft to the output shaft, the second shaft is a countershaft.

6. The powertrain according to claim 1, wherein a second drive unit is adapted to drive the propeller shaft via a second input shaft and a gearwheel pair.

7. The powertrain according to claim 6, wherein the second drive unit is one of an electric machine or an internal combustion engine or a gas turbine engine.

8. A vehicle comprising a powertrain according to claim 1.

9. A method for controlling a powertrain according to claim 1, the method comprising:
registering a request to disengage the power take-off device,
braking rotational speed of the power take-off device,
registering zero rotational speed of the power take-off device, and
disengaging the power take-off device.

10. A method for controlling a powertrain according to claim 1, the powertrain further comprising a rotational speed sensor adapted to measure rotational speed of the power take-off device, the method comprising:
if registering a faulty rotational speed signal from the rotational speed sensor, then initiating a failsafe mode,
where the failsafe mode comprises:
if registering a request to disengage the power take-off device, first braking rotational speed of the power take-off device, and
upon registering zero rotational speed of the power take-off device disengaging the power take-off device.

11. The method according to claim 9, comprising the control unit registering zero rotational speed of the power take-off device by registering that the first electric machine has reached zero rotational speed.

12. The method according to one of the claim 9, where before the step of braking rotational speed of the power take-off device, first disengaging the first electric machine from the propeller shaft.

13. A control unit configured to perform the method according to one of claim 9.
